(19) United States
(12) Patent Application Publication
(10) Pub. No.: US 2013/0201355 A1
(43) Pub. Date: Aug. 8, 2013

(54) IMAGING APPARATUS, IMAGING METHOD, AND RECORDING MEDIUM

(71) Applicant: OLYMPUS CORPORATION, Tokyo (JP)

(72) Inventor: Asako SEKI, Hino-shi (JP)

(73) Assignee: OLYMPUS CORPORATION, Tokyo (JP)

(21) Appl. No.: 13/831,086

(22) Filed: Mar. 14, 2013

Related U.S. Application Data
(63) Continuation of application No. PCT/JP2011/069602, filed on Aug. 30, 2011.

(30) Foreign Application Priority Data
Sep. 15, 2010 (JP) 2010-207122

(51) Int. Cl. H04N 5/225

(52) U.S. Cl. CPC H04N 5/225
USPC 348/207.1

(57) ABSTRACT

An imaging apparatus that obtains a plurality of image signals includes an object recognizing unit, an object focus setting unit, an image signal obtaining unit, and a display control unit. The object recognizing unit is configured to recognize an object in an image signal that has been obtained. The object focus setting unit is configured to set a plurality of focal lengths by using a result of object recognition by the object recognizing unit. The image signal obtaining unit is configured to obtain image signals at the plurality of focal lengths set by the object focus setting unit. The display control unit is configured to control the image signals obtained by the image signal obtaining unit so as to display the image signal consecutively.

### CROSS REFERENCE TO RELATED APPLICATIONS

This application is a Continuation Application of PCT Application No. PCT/JP2011/069602, filed Aug. 30, 2011 and based upon and claiming the benefit of priority from prior Japanese Patent Application No. 2010-207122, filed Sep. 15, 2010, the entire contents of all of which are incorporated herein by reference.

### BACKGROUND OF THE INVENTION

1. Field of the Invention

The present invention relates to an imaging apparatus and an imaging method for obtaining an image signal, and a recording medium for storing a program to allow a computer to execute a procedure of such an imaging apparatus.

2. Description of the Related Art

Image processing has been traditionally performed to obtain an image signal having an extended depth of field that is focused from near distances to far distances. For this purpose, depth of field extending processing, for example, is known where image signals of a plurality of captured images that are captured at different focal lengths are combined. In this depth of field extending processing, however, such processes as aligning and combining the image signals of the captured images have been time-consuming.

To cope with this challenge, Jpn. Pat. Appln. KOKAI Publication No. 2002-64741, for example, attempts to reduce processing time by inputting R image information into a real part of an FFT calculation unit, G image information into an imaginary part of the FFT calculation unit, B image information into the real part of the FFT calculation unit, and 0 into the imaginary part of the FFT calculation unit for calculation.

### BRIEF SUMMARY OF THE INVENTION

According to a first aspect of the invention, there is provided an imaging apparatus that obtains a plurality of image signals, comprising: an object recognizing unit configured to recognize an object in an image signal that has been obtained; an object focus setting unit configured to set a plurality of focal lengths by using a result of object recognition by the object recognizing unit; an image signal obtaining unit configured to obtain image signals at the plurality of focal lengths set by the object focus setting unit; and a display control unit configured to control the image signals obtained by the image signal obtaining unit so as to display the image signal consecutively.

According to a second aspect of the invention, there is provided an imaging apparatus that obtains a plurality of image signals, comprising: a focus setting unit configured to set a plurality of focal lengths; an image signal obtaining unit configured to obtain image signals at the plurality of focal lengths set by the focus setting unit; and a display control unit configured to control the image signals obtained by the image signal obtaining unit so as to display the image signals consecutively.

According to a third aspect of the invention, there is provided an imaging method used when a plurality of image signals are obtained, the method comprising: recognizing an object in an image signal that has been obtained; setting a plurality of focal lengths by using a result of recognition of the object; obtaining image signals at the plurality of focal lengths that have been set; and controlling the obtained image signals so as to display the image signal consecutively.

According to a fourth aspect of the invention, there is provided an imaging method used when a plurality of image signals are obtained, the method comprising: setting a plurality of focal lengths; obtaining image signals at the plurality of focal lengths that have been set; and controlling the obtained image signals so as to display the image signals consecutively.

According to a fifth aspect of the invention, there is provided a recording medium non-transitory storing a program configured to control a computer of an imaging apparatus that obtains a plurality of image signals, wherein the recording medium non-transitory stores a program configured to allow the computer to function as: an object recognizing unit configured to recognize an object in an image signal that has been obtained; an object focus setting unit configured to set a plurality of focal lengths by using a result of recognition of the object; an image signal obtaining unit configured to allow an image capture section to obtain image signals at the plurality of focal lengths that have been set; and a display control unit configured to control the obtained image signals so as to display the image signals consecutively.

According to a sixth aspect of the invention, there is provided a recording medium non-transitory storing a program configured to control a computer of an imaging apparatus that obtains of a plurality of image signals, wherein the recording medium non-transitory stores a program configured to allow the computer to function as: a focus setting unit configured to set a plurality of focal lengths; an image signal obtaining unit configured to allow an image capture section to obtain image signals at the plurality of focal lengths that have been set; and a display control unit configured to control the obtained image signals so as to display the image signals consecutively.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram of a configuration of an imaging apparatus according to a first embodiment of the present invention;

FIG. 2 is a diagram for describing a display sequence of image signals of a plurality of captured images;

FIG. 3 is a diagram of a configuration of an object focus setting section illustrated in FIG. 1;

FIG. 4A is a diagram for describing a method of setting focal lengths based only on positions and the number of a plurality of objects;

FIG. 4B is a diagram for describing a method of setting a focal length when objects are apart from each other in an optical axis direction;

FIG. 4C is a diagram for describing a method of setting a focal length when objects are close to each other in an optical axis direction (and when a target depth of field is not set);

FIG. 4D is a diagram for describing a method of setting a focal length when objects are close to each other in an optical axis direction (and when a target depth of field is set);

FIG. 5 is a flowchart of a program according to the first embodiment of the present invention;

FIG. 6 is a diagram of a configuration of an Imaging apparatus according to a second embodiment of the present invention;

FIG. 7 is a diagram of a configuration of a focus setting section illustrated in FIG. 6; and

FIG. 8 is a diagram for describing an exemplary method of setting focal lengths and the number thereof in the second embodiment.

### DETAILED DESCRIPTION OF THE INVENTION

Embodiments of the present invention will now he described with reference to the drawings.

### First Embodiment

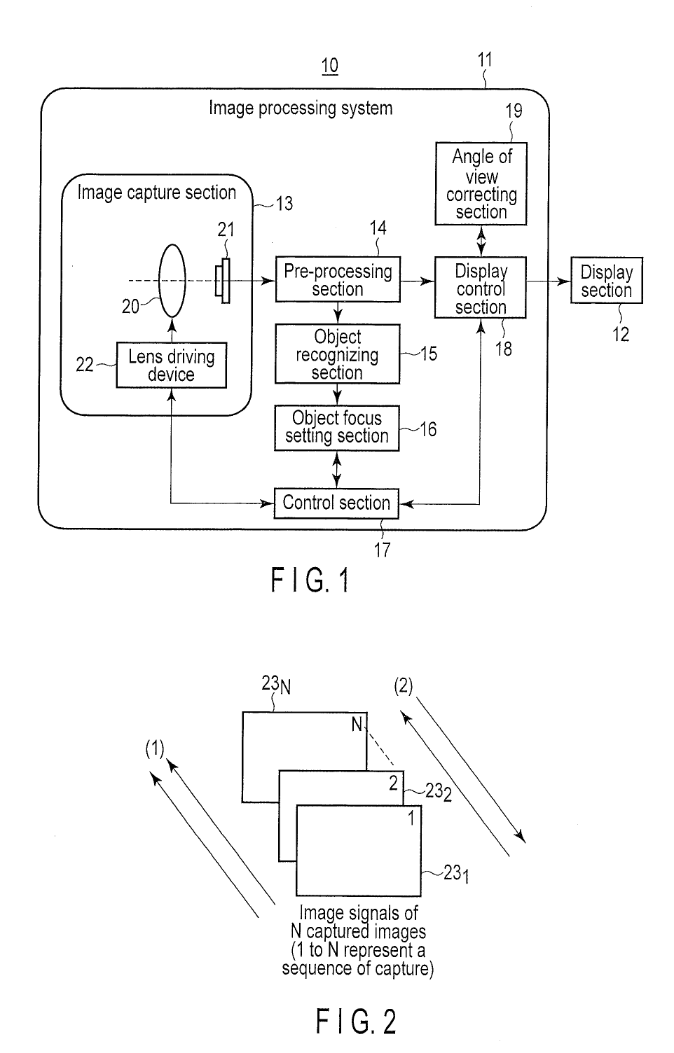

As illustrated in FIG. 1, an imaging apparatus 10 according to a first embodiment of the present invention includes an image processing system 11 that processes an image and a display section 12 that displays the image.

The image processing system 11 includes an image capture section 13, a pre-processing section 14, an object recognizing section 15, an object focus setting section 16, a control section 17, a display control section 18, and an angle of view correcting section 19. The image capture section 13 includes a lens module 20, a capture module 21, and a lens driving device 22.

The capture module 21 of the image capture section 13 is connected to the pre-processing section 14. The pre-processing section 14 is connected to the object recognizing section 15 and to the display control section 18. The object recognizing section 15 is connected to the object focus setting section 16. The object focus setting section 16 is connected to the control section 17. The control section 17 is bidirectionally connected to the lens driving device 22 in the image capture section 13 and to the display control section 18. The display control section 18 is connected to the display section 12. The angle of view correcting section 19 is connected to the display control section 18 bidirectionally.

The lens module 20 forms an image on the capture module 21. The capture module 21 photoelectrically converts the optical image of an object of interest formed by the lens module 20 into an electrical image signal. This image signal is transferred to the pre-Processing section 14. The lens driving device 22 controls the driving of the lens module 20 and the like.

The pre-processing section 14 executes processing such as analog-to-digital conversion on the obtained image signal and then transfers the signal to the object recognizing section 15. The object recognizing section 15 uses the image signal to recognize objects in the image and transfers information on the number of objects and the positions of objects to the object focus setting section 16. This object recognition may be any publicly known recognition such as face recognition and object recognition. The object focus setting section 16 uses a result of the recognition performed by the object recognizing section 15 to set a plurality of focal lengths. In the present embodiment, a focal length is set for each object recognized by the object recognizing section 15. In other words, the object focus setting section 16 sets the focal length by the number depending on the number of objects. The control section 17 transfers the focal lengths set by the object focus setting section 16 to the lens driving device 22 of the image capture section 13, and transfers the number of focal lengths to the display control section 18.

The lens driving device 22 drives the lens module 20 such that focusing is obtained at the focal lengths transferred. The lens driving device 22 may drive the capture module 21 in lieu of the lens module 20. The capture module 21 obtains an image signal every time such a driving operation is performed. This allows the capture module 21 to obtain a plurality of image signals focused at the focal lengths. Note that the object recognizing section 15 does not have to perform the object recognition every time the driving operation is performed. The object recognizing section 15 may perform the object recognition only once at the beginning for a still image, and once for any number of the driving operations for a moving image.

The pre-processing section 14 performs the analog-to-digital conversion on the plurality of image signals thus obtained, and transfers the image signals to the display control section 18. The display control section 18 performs control such that the image signals of a plurality of captured images are displayed consecutively. For a still image, the display control section 18 controls the obtained image signals of the plurality of captured images so as to display the image signals consecutively at a constant frame rate similarly to a moving image. For a moving image, processing similar to that for a still image is performed for one frame of the original moving image; therefore, a frame rate higher than that of a still image is necessary. The display control section 18 controls a display frame rate at the display section 12 in conformity with the number of focal lengths transferred through the control section 17 from the object focus setting section 16. The display control section 18 generally sets a higher frame rate proportionately with the number of focal lengths.

The angle of view correcting section 19 performs correction so as to obtain a similar angle of view for all of the image signals of the plurality of captured images transferred from the display control section 18. Examples of a means of correcting the angle of view at the angle of view correcting section 19 include a technique to obtain a constant angle of view by using a telecentric optical system and a technique to correct the angle of view through enlargement/reduction by digital signal processing. The display section 12 displays the plurality of captured images with an angle of view thereof corrected by the angle of view correcting section 19. Note that, while the imaging apparatus 10 includes the display section 12 in the present embodiment, the display section may be provided separately like a digital photo frame.

Concerning a method of switching and displaying the image signals of the plurality of captured images at the display section 12, since the image signals are displayed as they are being captured in the case of a moving image, as illustrated in FIG. 2 and marked with (1), image signals 23₁ to 23_{N} (where the subscripts 1, 2, . . . , N represent the sequence of image taking) are switched and displayed consecutively and iteratively in a sequence of capture (in chronological order). Alternatively, as illustrated in FIG. 2 and marked with (2), the image signals may be switched and displayed in a forward sequence of capture up to the newest image signal and then in a reverse chronological order, that is, in a reverse sequence of capture. For a still image, the image signals may also be displayed, after captured, in a random sequence that is different from the sequence of capture, besides the methods described above.

As described above, by capturing images at a plurality of focal lengths in accordance with positions of recognized objects, it is possible to obtain image signals of a plurality of captured images that are focused with different depths of field. These image signals of the plurality of captured images, when switched at a high speed and displayed, are recognized by human eyes as an image signal with an extended depth of field where objects from near distances to far distances are focused. This allows the image signal with the extended depth of field to be created without performing such processing as aligning and combining the image signals of the plurality of captured images and, therefore, produces an effect of extending a depth of field with reduced processing time for aligning, combining, and the like and without generating an artifact.

Each section of the imaging apparatus 10 in FIG. 1 will now be described in detail.

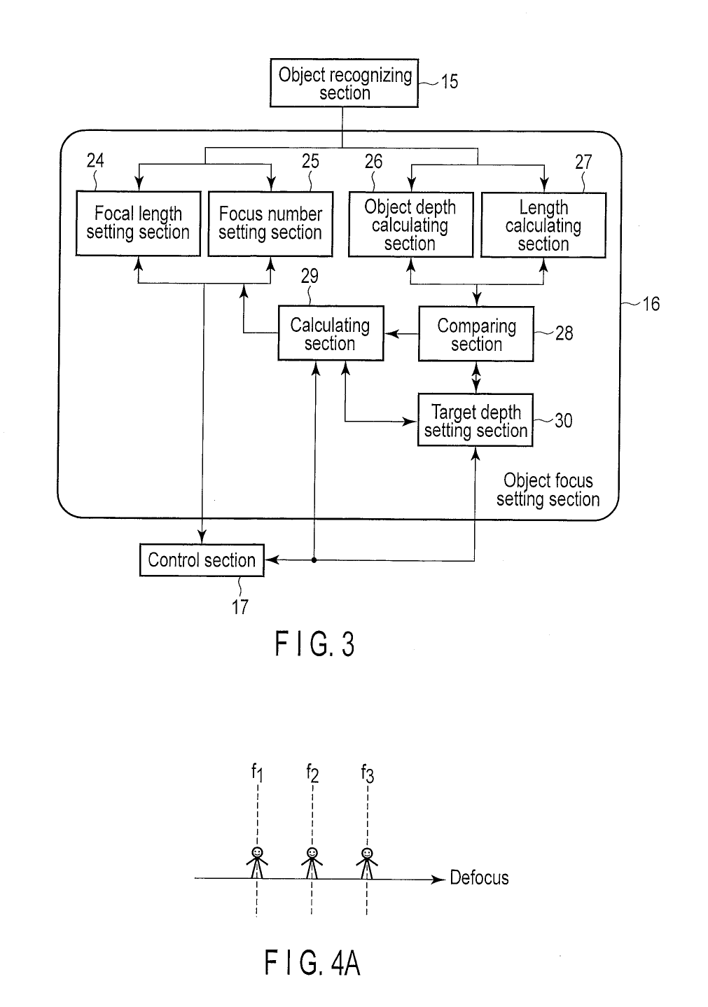

The object focus setting section 16 has a function, by using the positions of objects, to set focal lengths at which image signals are to be obtained and the number of focal lengths. As illustrated in FIG. 3, the object focus setting section 16 includes a focal length setting section 24, a focus number setting section 25, an object depth calculating section 26, a length calculating section 27, a comparing section 28, a calculating section 29, and a target depth setting section 30.

The object recognizing section 15 is connected to the focal length setting section 24, the focus number setting section 25, the object depth calculating section 26, and the length calculating section 27. The object depth calculating section 26 and the length calculating section 27 are connected to the comparing section 28. The comparing section 28 is connected to the calculating section 29. The calculating section 29 is connected to the focal length setting section 24 and the focus number setting section 25. The target depth setting section 30 is connected to the comparing section 28, the calculating section 29, and the control section 17 bidirectionally. The calculating section 29 is connected to the control section 17 bidirectionally. The focal length setting section 24 and the focus number setting section 25 are connected to the control section 17 bidirectionally.

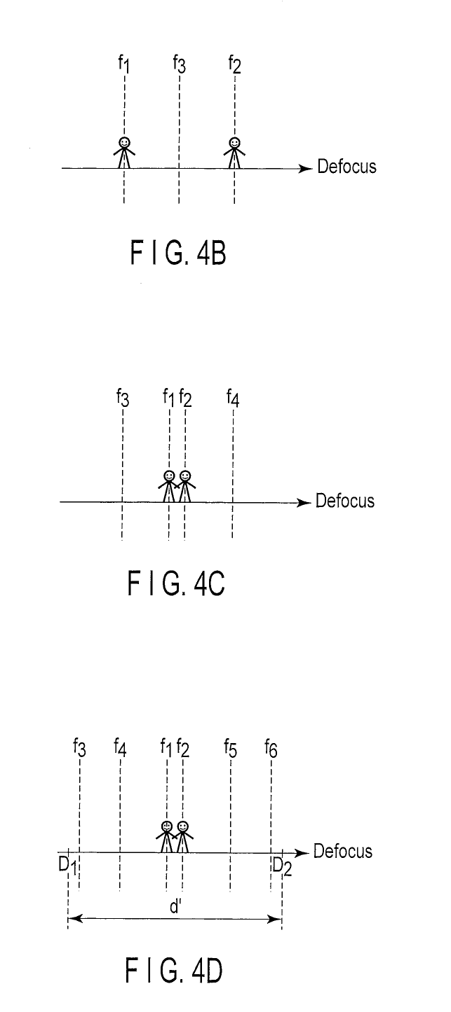

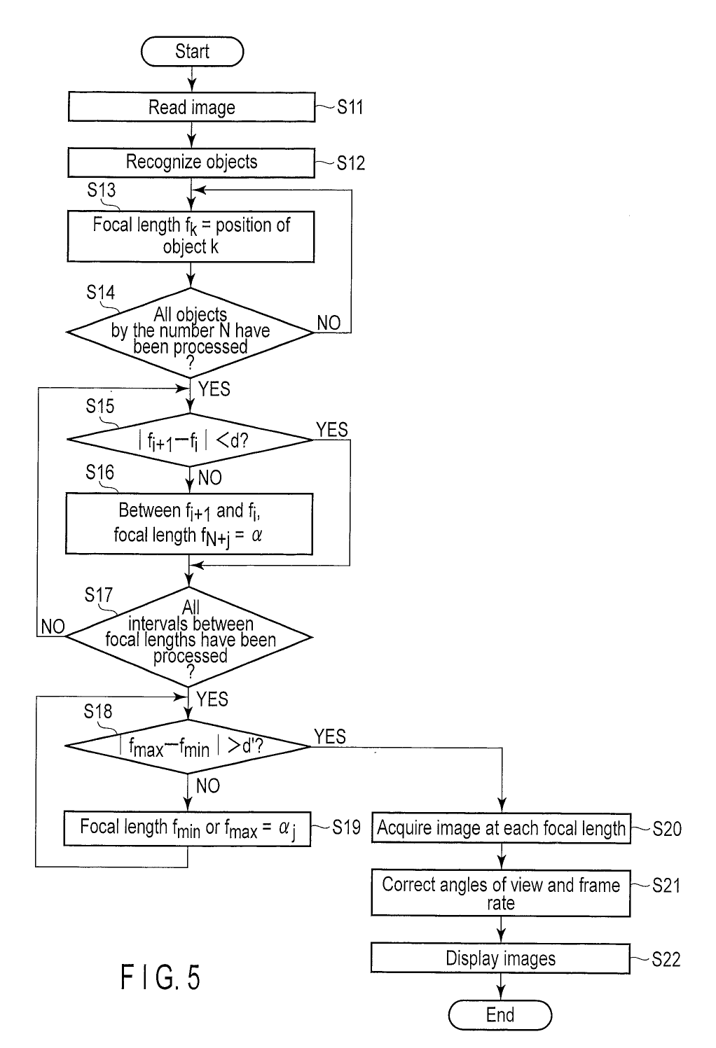

In the object focus setting section 16 as described above, the focal length setting section 24 uses a result of the object recognition performed by the object recognizing section 15 to determine focal lengths at which image signals are to be obtained. The focus number setting section 25 determines the number of focal lengths at which the image signals are to be obtained. For example, when the object recognizing section 15 has recognized three objects, the focal length setting section 24 determines f₁, f₂, f₃ as the focal lengths at which the image signals are to be obtained as illustrated in FIG. 4A, and the focus number setting section 25 determines that the number of focal lengths be “three.” The control section 17 controls the image capture section 13 and the display control section 18 in conformity with the determined focal lengths and the number thereof.

When there are a large number of objects as illustrated in FIG. 4A, the focal lengths and the number thereof may be set to the positions of the objects and the number thereof recognized by the object recognizing section 15. In some cases, however, such a simple control based only on the positions of the recognized objects and the number thereof may be insufficient. For example, as illustrated in FIG. 4B, when objects are located apart from each other in the optical axis direction, a blur may be observed in an interval between the objects because the interval is not within the depths of field at focal lengths f₁ and f₂. Conversely, when one object is present, or when objects are located close to each other in the optical axis direction as illustrated in FIG. 4C, the effect of extending the depth of field cannot be produced since focal lengths f₁ and f₂ of the objects are within one depth of field at focal length fᵢ.

When a blur is observed between the objects as illustrated in FIG. 4B, a focal length may be set at any position between the objects. For this purpose, in the present embodiment, the object depth calculating section 26 calculates depths of field at the positions of the objects by using a result of the object recognition performed by the object recognizing section 15. The length calculating section 27 calculates focal lengths for the positions of the objects and calculates a difference of the focal lengths between the objects. Here, the length calculating section 27 may obtain the focal lengths of objects by a different method, such as by using a sensor. The comparing section 28 compares the calculated depths of field and the difference of the focal lengths in order to determine whether or not a blur would be observed between the objects. Expression (1) below is employed as an exemplary conditional expression for determining whether or not a blur would be observed between objects. The object focus setting section 16 may, of course, also be configured to obtain another parameter to be used for another conditional expression.

|fᵢ₊₁−fᵢ|<d (1)

Note, in expression (1), fᵢ denotes any focal length that has been set, and d denotes a certain target depth of field calculated from the depths of field at the positions of the objects obtained by the object depth calculating section 26.

If it is determined that a blur would be observed between the objects, the calculating section 29 calculates f₃, a new focal length, between the objects that do not satisfy expression (1) in addition to focal lengths f₁ and f₂ set for the positions of the objects, so that expression (1) is satisfied. Accordingly, the newly calculated focal length, f₃, is set in the focal length setting section 24, and the updated number of focal lengths is set in the focus number setting section 25.

When one object is present, or when objects are located close to each other in the optical axis direction as illustrated in FIG. 4C, a focal length that is shorter or longer than those of the objects may be newly set. For this purpose, in the present embodiment, the length calculating section 27 calculates a maximum difference value between the focal lengths. The comparing section 28 compares the maximum difference value between the focal lengths calculated by the length calculating section 27 and a predetermined target depth of field to determine whether or not the maximum difference value between the focal lengths satisfies the target depth of field. Expression (2) below is employed as an exemplary conditional expression for this determination. The object focus setting section 16 may, of course, also be configured to obtain another parameter to be used for another conditional expression.

|fₘₐₓ−fₘᵢₙ|>d′ (2)

Note, in expression (2), fₘₐₓ denotes the longest focal length of the focal lengths that have been set with its initial value being xₘₐₓ, and fₘᵢₙ denotes the shortest focal length of the focal lengths that have been set with its initial value being xₘᵢₙ. Of the initial values, xₘₐₓ denotes the farthest distance of an object from the imaging apparatus 10; xₘᵢₙ denotes the nearest distance of an object from the imaging apparatus 10. Denoted by d′ is a target depth of field that is a certain depth of field having a value calculated from the depths of field at the positions of the objects obtained by the object depth calculating section 26. It is contemplated that this target depth of field, d′, may be the maximum value, the minimum value, or an average value of the depths of field at the positions of the objects. What value should be used should be determined in advance.

If it is determined that the maximum difference value between the focal lengths is smaller than the target depth of field, the calculating section 29 calculates a new focal length, which is denoted by f₃ and f₄ in the example illustrated in FIG. 4C, in addition to focal lengths f₁ and f₂ set for the positions of the objects, so that the target depth of field is satisfied. Accordingly, the newly calculated focal lengths, f₃ and f₄, are set in the focal length setting section 24, and the updated number of focal lengths is set in the focus number setting section 25. Such a newly set focal length may be shorter than fₘᵢₙ or longer than fₘₐₓ, or both may be used. Also, the focal lengths should be positioned such that expression (2) is satisfied. In this case, the number of objects does not agree with the number of focal lengths that have been set. The focal lengths and the number thereof may be, for example, preset or may be set through the control section 17. Conditions that should be satisfied here are that an interval between the objects is always within the depths of field provided at the positions of the objects and that a total of the depths of field reaches the target depth of field. Note, however, that the depths of field provided at the positions of the objects may have a gap therebetween to an extent that a blur is unrecognized.

As described above, expression (2) allows determination whether the positions of objects recognized by the object recognizing section 15 alone achieve a target depth of field or an effect of extending the depth of field. If it is determined that such an effect is not achieved, a new focal length can be set, which produces the effect of extending the depth of field even when an extended depth of field is not achieved by focusing at the positions of the objects.

Target depth of field d′ may be a value predetermined in the imaging apparatus 10, or any value set by a user. In such a case, a target depth of field is set through the control section 17 by the target depth setting section 30. The comparing section 28 then compares the maximum difference value between the focal lengths calculated by the length calculating section 27 and target depth of field d′ set by the target depth setting section 30 to determine whether or not the maximum difference value between the focal lengths satisfies target depth of field d′. When target depth of field d′ has been set as described above, focal lengths f₃, f₄, f₅, and f₆, which may be shorter or longer than the focal lengths of the objects, should be newly positioned as illustrated in FIG. 4D, such that target depth of field d′ (focal length D₁ to focal length D₂) and expression (2) above are both satisfied.

Note that, while the object recognizing section 15 and the object focus setting section 16 described above are configured as independent hardware, it is also possible to achieve the functions described above by allowing a recording medium storing a software program that achieves a function of the object recognizing section 15 and the object focus setting section 16 to provide the program to a computer that constitutes the control section 17 and executes the program.

In other words, as illustrated in the flowchart of FIG. 5, the computer reads an image signal obtained by the image capture section 13 (step S11), and then recognizes a plurality of objects from the image signal (step S12). A position of one of the plurality of objects that have been recognized is then set as a focal length (step S13). Alter that, it is determined whether a focal length has been set for every object (step S14). If it is determined that a focal length has not been set for every object yet, the processing reverts back to step S13 to process succeeding one object. If it is determined that all objects have been processed, the processing moves on to step S15.

That is, when a focal length has been set for every object, it is then determined whether or not a blur would be observed in one interval between objects by using a conditional expression represented by expression (1) above (step S15). If the conditional expression represented by expression (1) above is not satisfied, in other words, if it is determined that a blur would be observed in the interval between the objects, a new focal length is provided between the focal lengths of the objects (step S17). Here, a focal length is interpolated. If it is determined that the conditional expression represented by expression (1) above is satisfied, in other words, if a blur would not be observed in the interval between the objects, step S16 is bypassed. It is then determined whether all intervals between the focal lengths have been processed (step S17). If it is determined that all intervals between the focal lengths have not been processed, the processing reverts back to step S15 above to perform the determination for a succeeding one interval between focal lengths. If it is determined that all focal lengths have been processed, the processing moves on to succeeding step S17.

That is, if it is determined that all intervals between the focal lengths have been processed, it is then determined whether or not the maximum difference value between the focal lengths satisfies the target depth of field by using a conditional expression represented by expression (2) above (step S18). If the conditional expression represented by expression (2) is not satisfied, in other words, if the maximum difference value between the focal lengths does not satisfy the target depth of field, a new focal length is provided (step S19) and the processing then reverts back to step S18 above. In this case, the focal length to be newly provided is set to a value smaller than fₘᵢₙ or a value greater than fₘₐₓ, and then fₘᵢₙ and fₘₐₓ are updated. In this processing, a focal length is newly set such that the focal length, when set, will achieve the target depth of field or an extended depth of field.

If the conditional expression represented by expression (2) is satisfied in step S18 described above, in other words, if the maximum difference value between the focal lengths satisfies the target depth of field, the processing moves on to succeeding step S20 since the target depth of field or an extended depth of field is considered achieved. That is, the image capture section 13 is allowed to obtain image signals at a plurality of focal lengths set as described above (step S20). The angle of view correcting section 19 is then allowed to correct each of the angles of view of the plurality of image signals that have been obtained, and also, the display control section 18 is allowed to control a frame rate according to the number of focal lengths that have been set (step S21). Instead of providing the angle of view correcting section 19 and the display control section 18, a computer constituting the control section 17 may perform the angle of view correction and the frame rate control. Subsequently, the plurality of corrected image signals and the controlled frame rate are used to switch and display these image signals on the display section 12 (step S22), before finishing the processing.

As described above, the imaging apparatus 10 according to the present first embodiment allows the object recognizing section 15 to recognize objects, the object focus setting section 16 to set a plurality of focal Lengths in accordance with the objects recognized by the object recognizing section 15, and the image capture section 13 to obtain image signals at the plurality of focal lengths set by the object focus setting section 16. By obtaining the image signals at the plurality of focal lengths in accordance with the positions of the recognized objects as described above, it is possible to obtain image signals of the plurality of captured images each focused at a different depth. Then by switching and displaying the plurality of obtained image signals, it is possible to produce the effect of extending the depth of field with reduced processing time for aligning, combining, and the like and without generating an artifact.

In addition, the display section 12 is allowed to, without performing such processing as combining and aligning, switch and display at the display section 12 the image signals obtained by the image capture section 13 at the plurality of focal lengths. This enables an image with an extended depth of field to be obtained since the image signals of the plurality of captured images each focused at a different depth are sequenced.

In addition, the angle of view correcting section 19 is allowed to perform correction so as to prevent the angles of view from varying corresponding to the varying focal lengths. By correcting the angles of view of the plurality of image signals obtained by the image capture section 13 for a common angle of view as described above, it is possible to obtain a high quality image signal to be displayed without a variation in the angle of view.

in addition, the focal length setting section 24 is allowed to set focal lengths in accordance with the positions of the objects recognized by the object recognizing section 15, and the focus number setting section 25 is allowed to set the number of objects recognized by the object recognizing section 15 as the number of focal lengths to be set. In this way, it is possible to obtain an image with all objects in the image focused since the focal lengths are set in accordance with the recognized objects.

In addition, the length calculating section 27 is allowed to calculate the focal lengths of the objects recognized by the object recognizing section 15, and a plurality of focal lengths including at least the focal lengths calculated by the length calculating section 27 is set such that a maximum difference value between the focal lengths that have been set satisfies the target depth of field set by the target depth setting section 30. In other words, in addition to the focal lengths set in accordance with the positions of the recognized objects, a further focal length is set such that the maximum difference value between the focal lengths that have been set satisfies the target depth of field. Hence, a new focal length is set in addition to those set at the positions of the object, and therefore, it is possible to obtain an image with an extended depth of field even when the use of the positions of the objects alone does net achieve the extension of the depth. It is also possible to obtain an image that is focused at the positions of the objects and satisfies the target depth of field.

In addition, the display control section 18 is allowed to control the display frame rate for the image signals to be displayed at the display section 12 in a manner dependent upon the number of focal lengths that have been set. Hence, it is possible to obtain a high quality image since the display frame rate is controlled in a manner dependent upon the number of focal lengths that have been set.

### Second Embodiment

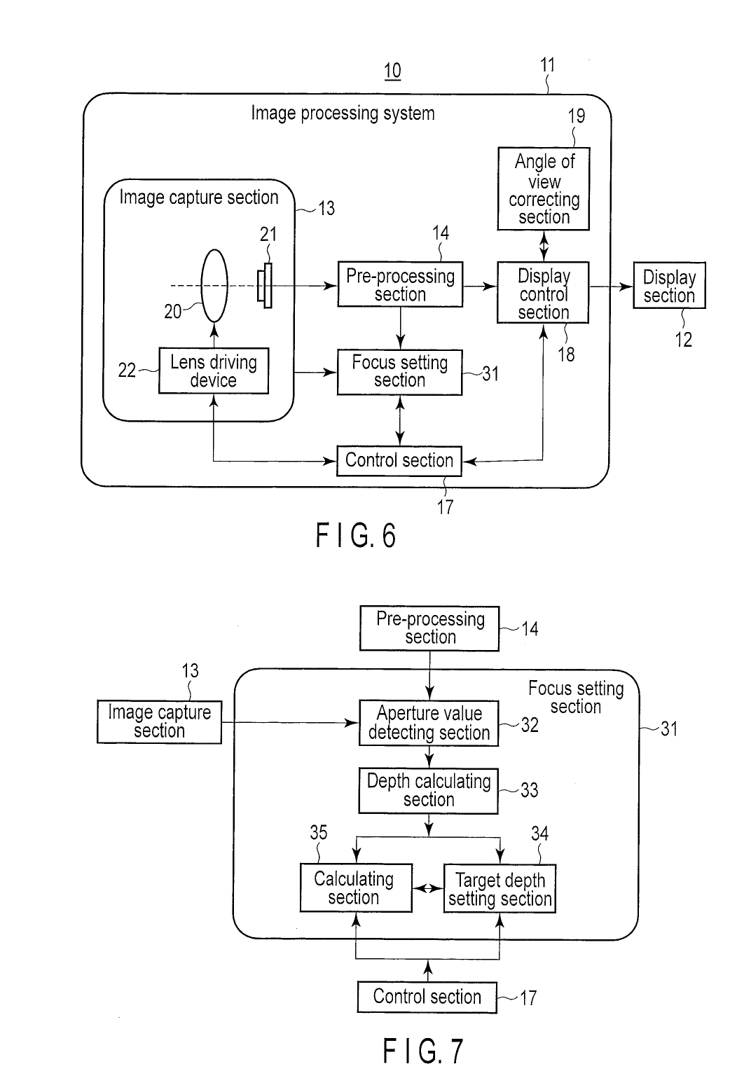

FIG. 6 is a diagram of a configuration of an imaging apparatus 10 according to a second embodiment of the present invention. In FIG. 6, like references indicate blocks with similar functions illustrated in FIG. 1, and similar descriptions will not be repeated.

The imaging apparatus 10 according to the present second embodiment includes a focus setting section 31 in place of the object recognizing section 15 and the object focus setting section 16 in the imaging apparatus 10 according to the first embodiment. An image capture section 13 and a pre-processing section 14 are connected to the focus setting section 31. The focus setting section 31 is also connected to a control section 17 bidirectionally.

A flow of a signal will be described with reference to FIG. 6. Similar descriptions to those in the first embodiment will not be repeated here. The focus setting section 31 uses a pre-processed image signal and an aperture value obtained from the image capture section 13 to set focal lengths and the number thereof. The focal lengths and the number thereof set by the focus setting section 31 are transferred through the control section 17 to a lens driving device 22 of the image capture section 13. The lens driving device 22 drives a lens module 20 to focus at the transferred focal lengths. Similarly, the number of focal lengths set by the focus setting section 31 is transferred through the control section 17 to a display control section 18.

FIG. 7 is a diagram of an exemplary configuration of the focus setting section 31. The focus setting section 31 has a function to set focal lengths at which image signals are to be obtained and the number of focal lengths, and includes an aperture value detecting section 32, a depth calculating section 33, a target depth setting section 34, and a calculating section 35.

The image capture section 13 and the pre-processing section 14 are connected to the aperture value detecting section 32. The aperture value detecting section 32 is connected to the depth calculating section 33, and the depth calculating section 33 is connected to the target depth setting section 34 and the calculating section 35. The calculating section 35 is connected to the target depth setting section 34 and the control section 17 bidirectionally. The target depth setting section 34 is connected to the control section 17 bidirectionally.

In the focus setting section 31 as described above, the aperture value detecting section 32 detects an aperture value based on the image signal of the captured image from the pre-processing section 14 and information obtained from the image capture section 13. The depth calculating section 33 calculates a depth of field at each focal length from the aperture value detected by the aperture value detecting section 32. Here, the depth of field may be calculated by another method besides using an aperture value. When another method is used, the aperture value detecting section 32 may be excluded. Each focal length described above refers to each of any plurality of focal lengths or any one focal length of the focal lengths the image capture section 13 can possibly use.

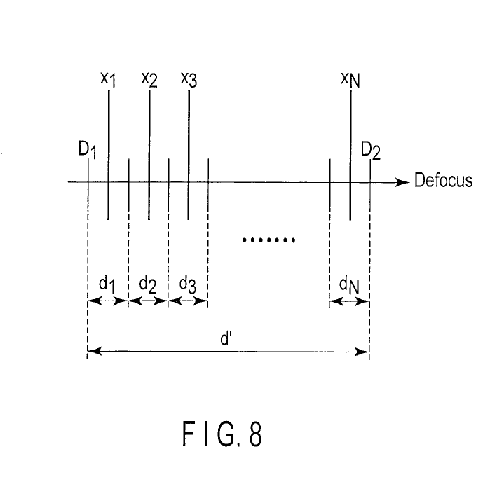

The target depth setting section 34 has a target depth of field that is predetermined or set by a user through the control section 17. The calculating section 35 uses the target depth of field set in the target depth setting section 34 and the depth of field at each focal length obtained by the depth calculating section 33 to calculate focal lengths at which image signals are to be obtained and the number of focal lengths for extension of the depth of field. An exemplary method of this calculation is illustrated in FIG. 8. As described in detail below, focal lengths are positioned such that the depth of field at each focal length does not overlap with each other, and the number N of focal lengths to be set is derived such that a total of the depths of field at the positioned focal lengths is equal to the target depth set by the target depth setting section 34. The focal lengths and the number thereof derived as described above are transferred through the control section 17 to the image capture section 13 and a display control section 18.

By capturing images focused at the plurality of focal lengths set independently of the positions of the objects as described above, it is possible to obtain image signals of the plurality of captured images focused with different depths. These image signals of the plurality of captured images, when switched at a high speed and displayed, are recognized by human eyes as an image signal with an extended depth of field that is focused from near distances to far distances. This allows the image signal with the extended depth of field to be created without performing such processing as aligning and combining the image signals of the plurality of captured images and, therefore, produces the effect of extending a depth of field with reduced processing time for aligning, combining, and the like and without generating an artifact.

FIG. 8 is a diagram of an exemplary method of setting focal lengths and the number thereof at the focus setting section 31. The focus setting section 31 sets focal length xᵢ and the number N thereof in order to satisfy target depth of field d′ (focal length D₁ to focal length D₂). When depths of field d₁ to d_{N} at the obtained focal lengths are assumed to be a constant value d₀, the number N of focal lengths can be obtained through expression (3) below.

$$N \approx \frac{{D}_{2} - {D}_{1}}{{d}_{0}} \qquad ( 3 )$$

Focal length xᵢ can be obtained through expression (4) below.

$${x}_{i} \approx {d}_{0} ( i - 1 ) + \frac{{d}_{0}}{2} + {D}_{1} \qquad ( 4 )$$

While, in the case described above, focal lengths are set such that a target depth of field is filled with the depths of field at the focal lengths without a gap, the target depth of field does not always have to be filled without a gap. It is contemplated that a gap to an extent that an observer does not recognize a blur between depths of field at different focal lengths will not be a problem.

When the depths of field to be obtained are not constant at different focal lengths (when depths of field at the plurality of focal lengths are obtained at the depth calculating section 33), the number N of focal lengths will be an N that satisfies expression (5) below, where a depth of field at focal length xⱼ is dⱼ.

$${\sum }_{j = 1}^{N} {d}_{j} \approx {D}_{2} - {D}_{1} \qquad ( 5 )$$

Focal length xᵢ can be obtained through expression (6) below.

$${x}_{i} \approx {\sum }_{j = 1}^{i - 1} {d}_{j} + \frac{{d}_{i}}{2} + {D}_{1} \qquad ( 6 )$$

While, in this case, similarly to expression (3) and expression (4), focal lengths are set such that a target depth of field is filled with the depths of field at the focal lengths without a gap, the target depth of field does not always have to be filled without a gap. It is contemplated that a gap to an extent that an observer does not recognize a blur between depths of field at different focal lengths will not be problem.

Note that, in the present second embodiment, similarly to the first embodiment, besides configuring the focus setting section 31 as independent hardware, it is of course possible to achieve the functions described above by allowing a computer that constitutes the control section 17 to execute a software program that is stored in a recording medium and achieves a function of the focus setting section 31.

As described above, the imaging apparatus 10 according to the present second embodiment allows the focus setting section 31 to set a plurality of focal lengths and the image capture section 13 to obtain image signals at the plurality of focal lengths set by the focus setting section 31. By obtaining image signals with focusing at the plurality of focal lengths set by the focus setting section 31 as described above, it is possible to obtain image signals of the plurality of captured images focused with different depths. Then by switching and displaying the plurality of obtained image signals, it is possible to produce the effect of extending the depth of field with reduced processing time for aligning, combining, and the like and without generating an artifact.

In addition, the display section 12 is allowed to, without performing such processing as combining and aligning, switch and display at the display section 12 the image signals obtained by the image capture section 13 at the plurality of focal lengths. Hence, this enables an image with an extended depth of field to be obtained since the image signals of the plurality of captured images each focused at a different depth are sequenced.

In addition, the angle of view correcting section 19 is allowed to perform correction so as to prevent the angles of view from varying corresponding to the varying focal lengths. By correcting the angles or view of the plurality of image signals captured by the image capture section 13 for a common angle of view as described above, it is possible to obtain a high quality image signal to be displayed without a variation in the angle of view.

In addition, by using the target depth set by the target depth setting section 34, focal lengths and the number thereof are determined. By using the target depth that has been set in this way, focal lengths can be set efficiently.

In addition, the depth calculating section 33 is allowed to calculate a depth of field at each focal length, the target depth setting section 341 is allowed to set a target depth of field, and the calculating section 35 is allowed to determine focal lengths and the number thereof by using the depth of field at each focal lengths calculated by the depth calculating section 33 and the target depth of field set by the target depth setting section 34. By determining the focal lengths and the number thereof by using the depth of field at each focal length and the target depth of field that has been set as described above, the focal lengths can be set efficiently, thereby reducing the processing time.

In addition, the aperture value detecting section 32 is allowed to calculate an aperture value at the image capture section 13, the depth calculating section 33 is allowed to calculate a depth of field at each focal length by using the aperture value calculated by the aperture value detecting section 32, the target depth setting section 34 is allowed to set a target depth of field, and the calculating section 35 is allowed to determine focal lengths and the number thereof by using the depth of field at each focal length calculated by the depth calculating section 33 and the target depth of field set by the target depth setting section 34. By determining the focal lengths and the number thereof by using the depth of field at each focal lengths obtained by using the aperture value and the target depth of field that has been set as described above, the focal lengths can be set efficiently, thereby reducing the processing time.

In addition, the display control section 18 is allowed to control the display frame rate for the image signals to be displayed at the display section 12 in a manner dependent upon the number of focal lengths that have been set. Hence, it is possible to obtain a high quality image since the display frame rate is controlled in a manner dependent upon the number of focal lengths that have been set.

While the present invention is described according to some embodiments, the present invention is not limited to the embodiments described above, and various modifications and applications within the spirit of the present invention are of course possible.

For example, in the above embodiments, an imaging apparatus 10 is described by using, as an example, a device that immediately displays images captured by an image capture section 13, such as a live-view display in a digital camera and an image display for observation in an endoscopic apparatus. Conversely, image signals of a plurality of captured images may of course be stored to be displayed by such a device later.

Furthermore, the imaging apparatus 10 may perform processing from obtaining image signals of a plurality of captured images up to storing them in a recording medium and allow a separate display device to switch and display the image signals of the plurality of captured images stored in the recording medium at a controlled frame rate therefor (together with a controlled angle of view, as appropriate). The approaches described above, of course, also allow the image signal with the extended depth of field to he created without performing such processing as aligning and combining on image signals of a plurality of captured images and, therefore, produces the effect of extending a depth of field with reduced processing time for aligning, combining, and the like and without generating an artifact.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imaging apparatus that obtains a plurality of image signals, comprising:
an object recognizing unit configured to recognize an object in an image signal that has been obtained;
an object focus setting unit configured to set a plurality of focal lengths by using a result of object recognition by the object recognizing unit;
an image signal obtaining unit configured to obtain image signals at the plurality of focal lengths set by the object focus setting unit; and
a display control unit configured to control the image signals obtained by the image signal obtaining unit so as to display the image signal consecutively.

2. The imaging apparatus according to claim 1, further comprising a display unit configured to display the image signals at the plurality of focal lengths obtained by the image signal obtaining unit.

3. The imaging apparatus according to claim 1, further comprising a correcting unit configured to perform correction so as to prevent an angle of view from varying corresponding to a variation of the focal lengths.

4. The imaging apparatus according to claim 1, wherein
the object focus setting unit includes:
a focal length setting unit configured to set the focal lengths at a position of the object recognized by the object recognizing unit; and
a focus number setting unit configured to set the number of focal lengths to be set by using the number of objects.

5. The imaging apparatus according to claim 1, wherein
the object focus setting unit includes:
a length calculating unit configured to calculate the focal lengths of each of the object recognized by the object recognizing unit; and
a target depth setting unit configured to set a target depth of field, and
the object focus setting unit sets a plurality of focal lengths including at least the focal lengths calculated by the length calculating unit such that a maximum difference value between the focal lengths calculated by the length calculating unit satisfies the target depth of field set by the target depth setting unit.

6. The imaging apparatus according to claim 2, wherein
the display control unit includes a frame rate setting unit configured to set a display frame rate, and
the frame rate is controlled depending on the number of focal lengths that have been set.

7. An imaging apparatus that obtains a plurality of image signals, comprising:
a focus setting unit configured to set a plurality of focal lengths;
an image signal obtaining unit configured to obtain image signals at the plurality of focal lengths set by the focus setting unit; and
a display control unit configured to control the image signals obtained by the image signal obtaining unit so as to display the image signals consecutively.

8. The imaging apparatus according to claim 7, further comprising a display unit configured to display the image signals at the plurality of focal lengths obtained by the image signal obtaining unit.

9. The imaging apparatus according to claim 7, further comprising a correcting unit configured to perform correction so as to prevent an angle of view from varying corresponding to a variation of the focal lengths.

10. The imaging apparatus according to claim 7, wherein
the focus setting unit includes a target depth setting unit configured to set a target depth of field, and
the focus setting unit sets the focal lengths and the number thereof by using the target depth of field set by the target depth setting unit.

11. The imaging apparatus according to claim 10, wherein
the focus setting unit further includes a depth of field calculating unit configured to calculate a depth of field at each focal length, and
the focus setting unit sets the focal lengths and the number thereof by using the target depth of field set by the target depth setting unit and the depth of field at each focal length calculated by the depth of field calculating unit.

12. The imaging apparatus according to claim 11, wherein
the focus setting unit further includes an aperture value detecting unit configured to detect an aperture value of an optical module of the imaging apparatus, and
the depth of field calculating unit calculates the depth of field at each focal length by using the aperture value detected by the aperture value detecting unit.

13. The imaging apparatus according to claim 8, wherein
the display control unit includes a frame rate setting unit configured to set a display frame rate, and
the frame rate is controlled depending on the number of focal lengths that have been set.

14. An imaging method used when a plurality of image signals are obtained, the method comprising:
recognizing an object in an image signal that has been obtained;
setting a plurality of focal lengths by using a result of recognition of the object;
obtaining image signals at the plurality of focal lengths that have been set; and
controlling the obtained image signals so as to display the image signal consecutively.

15. An imaging method used when a plurality of image signals are obtained, the method comprising:
setting a plurality of focal lengths;
obtaining image signals at the plurality of focal lengths that have been set; and
controlling the obtained image signals so as to display the image signals consecutively.

16. A recording medium non-transitory storing a program configured to control a computer of an imaging apparatus that obtains a plurality of image signals, wherein the recording medium non-transitory stores a program configured to allow the computer to function as:
an object recognizing unit configured to recognize an object in an image signal that has been obtained;
an object focus setting unit configured to set a plurality of focal lengths by using a result of recognition of the object;
an image signal obtaining unit configured to allow an image capture section to obtain image signals at the plurality of focal lengths that have been set; and
a display control unit configured to control the obtained image signals so as to display the image signals consecutively.

17. A recording medium non-transitory storing a program configured to control a computer of an imaging apparatus that obtains of a plurality of image signals, wherein the recording medium non-transitory stores a program configured to allow the computer to function as:
a focus setting unit configured to set a plurality of focal lengths;
an image signal obtaining unit configured to allow an image capture section to obtain image signals at the plurality of focal lengths that have been set; and
a display control unit configured to control the obtained image signals so as to display the image signals consecutively.
